(19) United States
(12) Patent Application Publication
(10) Pub. No.: US 2026/0169779 A1
(43) Pub. Date: Jun. 18, 2026

(54) SECURE EXPOSURE OF REGISTERS TO VIRTUAL FUNCTIONS

(71) Applicant: ATI TECHNOLOGIES ULC, MARKHAM (CA)

(72) Inventors: Yinan Jiang, Markham (CA); Dezhi Ming, Markham (CA); Vignesh Chander, Markham (CA)

(21) Appl. No.: 18/980,923

(22) Filed: Dec. 13, 2024

(51) Int. Cl. G06F 9/455

(52) U.S. Cl. CPC G06F 9/45558; G06F 2009/4557

(57) ABSTRACT

A processing system includes a plurality of resources configured to store information and physical function circuitry configured to execute a virtual function using information stored in the plurality of resources. A processing unit is configured to designate a subset of the plurality of resources as safe to be exposed to the virtual function based on an operational state of the processing unit. The plurality of resources can include frame buffers, context registers, doorbell registers, and mailbox registers that are selectively accessible to the virtual function based on the operational state of the processing unit. In that case, the processing unit is configured to designate a subset of the context registers as safe to be exposed to the virtual function.

### BACKGROUND

Processing units such as graphics processing units (GPUs) support virtualization that allows multiple virtual machines to share the hardware resources of the processing unit. Each virtual machine executes as a separate process using the hardware resources of the processing unit. Some virtual machines implement an operating system (OS) to emulate an actual machine; other virtual machines execute code in a platform-independent environment. A hypervisor creates and runs the virtual machines, which are also referred to as guest machines or guests. A processing unit typically includes physical function circuitry to perform different functions for the processing unit. The physical function circuitry can also be referred to as “the physical function.” The physical function can support one or more virtual functions that share the resources of the physical function on a time-sliced or time-multiplexed basis. For example, the physical function can be allocated to a first virtual function running on a first virtual machine in a first time interval and the physical function can be allocated to a second virtual function running on a second virtual machine in a subsequent second time interval.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system that includes a parallel processor that safely exposes resources to virtual functions that share a physical function in a virtualized environment according to some embodiments.

FIG. 2 is a block diagram of a processing system that designates resources as “safe” to be accessed by virtual functions (VFs) at runtime according to some embodiments.

FIG. 3 is a block diagram of a state machine that is used to determine the state of a VF and selectively enable resources access by the VF according to some embodiments.

FIG. 4 illustrates resources of a parallel processor according to some embodiments.

FIG. 5 is a method of designating subsets of registers as safe for access by one or more virtual functions according to some embodiments.

### DETAILED DESCRIPTION

Processing units can operate in a native environment or a virtual environment. For example, the single root input/output virtualization (SR IOV) specification allows hardware resources of a GPU or other parallel processor to be shared between a physical function (PF) and one or more virtual functions (VFs). Each virtual function is associated with one physical function and the virtual function is implemented using the physical resources and circuitry of the associated physical function. The virtual functions are disabled when the parallel processor is operating in a native (or host OS) environment and the physical functions are used by native user mode and kernel mode drivers. The processor resources are mapped to the physical function via trusted access in the native environment. When the processor is operating in a virtual environment, the physical function is used by a hypervisor (or host virtual machine, VM) and the GPU exposes one or more virtual functions. The hypervisor can assign the virtual functions to guest VMs. Subsets of the processor's information storage resources (e.g., registers) are mapped to the virtual functions. The subsets are partitioned to include a frame buffer, context registers, a doorbell aperture, and one or more mailbox registers used for VF-PF synchronization.

Access to the mapped subsets of the processor's information storage resources is controlled based on the operational state of the processor. The host driver enables VF access to the mailbox registers to support communication between the VF and the PF that implements the VF in all operational states. During initialization of a VF, the host driver also enables VF access to the frame buffer, context registers, and doorbell. The host driver then disables access to some of the mapped resources after initialization is complete. For example, the host driver can disable VF access to the context registers at runtime to avoid corruption or race conditions caused by the host driver and the VF concurrently accessing the same context register. Consequently, the VF cannot use the context registers to initiate actions and the host driver is required to perform these actions on behalf of the VF. For example, if the VF detects a condition that requires a reset or re-initialization of the VF, the VF transmits a request for the action to the host driver via an enabled mailbox register(s). In response to the request, the host driver instructs an entity such as a micro-engine to perform the reset or re-initialization. Once the requested action is complete, the host driver transmits an acknowledgment to the VF via the mailbox register(s).

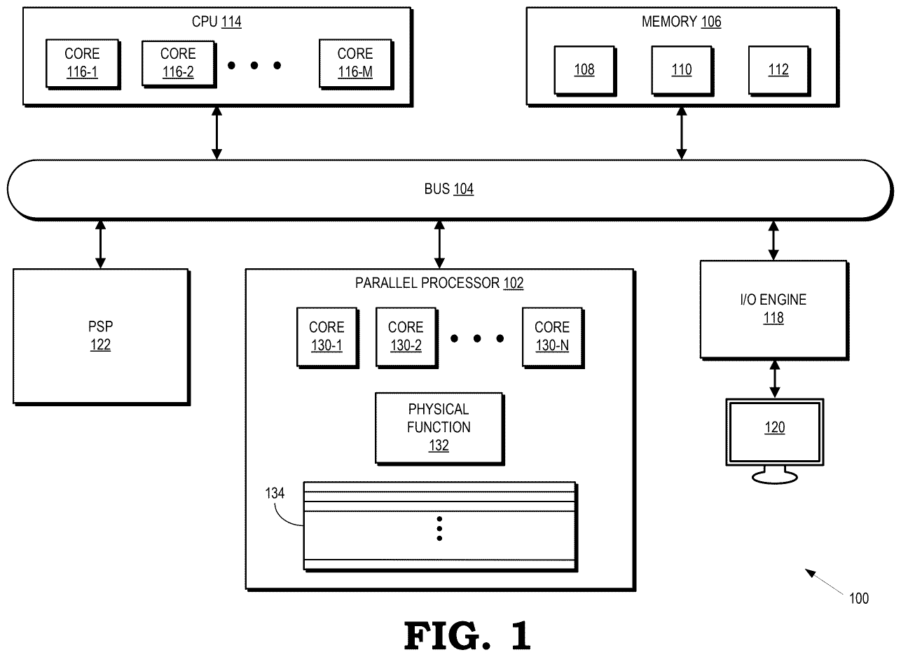

FIGS. 1-5 depict systems and methods for reducing the signaling overhead and latency incurred by VF requests to the host driver by designating a subset of the information storage resources as “safe” to be exposed to a VF at runtime. Exposing a resource such as a register to the VF at runtime also potentially allows a malicious actor to write invalid values to the exposed resource, e.g., as part of a fuzzer attack or denial of service attack. A resource or a subset of resources is considered “safe” for exposure to the VF at runtime if writing invalid values to the safe subset does not disrupt operation of the processing unit. Furthermore, attempts to access resources or registers outside of the safe subset are blocked so that attempts to disrupt operation of the processing unit by writing to the safe subset and regions outside the safe subset are not permitted. In some cases, the safe subset includes a subset of the context registers. The safe subsets of the information storage resources are defined by an address, a register size, a starting address, an ending address, and the like. If the processing unit supports multiple VFs, multiple safe subsets are defined for corresponding VFs and the subsets defined for different VFs can be the same or different.

A processor dedicated to performing operations related to security, such as a platform security processor (PSP), can initialize register pairs as safe registers at boot time. For example, the PSP can initialize eight range register pairs (i.e., two registers for each range) at boot time. In response to a driver of the PF detecting the VF state, the PF driver operates in conjunction with PSP to initialize and configure one or more enable registers to indicate the VFs associated with each of the register pairs. The number or size of the safe subsets, e.g., the number or length of the safe context registers, can be different for different VF. The VF initiates actions by writing information to the safe subset of the information storage resources, such as one or more safe context registers assigned to the VF. In some embodiments, the VF initiates a reset or re-initialization of the VF by writing a request to the safe subset of the context registers. In some embodiments, the VF initiates a peripheral component interconnect-express (PCIe) bus cache invalidation for this VF during run time. Then, in response to the PF driver detecting the VF state change, e.g., the VF driver ends or a guest VM crashes, the PF driver operates in conjunction with the PSP to disable the VF's access to the predefined register ranges.

FIG. 1 is a block diagram of a processing system 100 that includes a parallel processor 102 that safely exposes resources to virtual functions that share a physical function in a virtualized environment according to some embodiments. The parallel processor 102 is implemented using circuitry to perform parallel processing. Examples of parallel processors include a graphics processing unit (GPU), a general-purpose GPU (GPGPU), a neural processing unit (NPU), or other vector processor or type of parallel processor. The parallel processor 102 can also be referred to as a processing unit. The processing system 100 includes circuitry to implement a shared medium such as a bus 104 to support communication between entities or other circuitry in the processing system 100. Some implementations of the processing system 100 include circuitry that implements other shared media such as buses, bridges, switches, routers, and the like, which are not shown in FIG. 1 in the interest of clarity.

Processing system 100 includes or has access to a memory 106 or other storage component implemented using a non-transitory computer-readable medium, for example, a dynamic random-access memory (DRAM). However, in implementations, the memory 106 is implemented using other types of memory including, for example, static random-access memory (SRAM), nonvolatile RAM, and the like. Some embodiments of the memory 106 include an external memory implemented external to the processing units implemented in the processing system 100. Some embodiments of the memory 106 store information representing instructions such as program code 108 for one or more applications (e.g., graphics applications, compute applications, machine-learning applications), data 110 that is consumed by the program code 108 and results 112 produced by executing the program code 108.

The processing system 100 shown in FIG. 1 also includes a central processing unit (CPU) 114 that is connected to the bus 104 to communicate with other entities in the processing system 100, such as the memory 106. The CPU 114 includes circuitry that implements a plurality of processor cores 116-1 to 116-M that execute instructions concurrently or in parallel. In some implementations, one or more of the processor cores 116 operate as SIMD units that perform the same operation on different data sets. Although in the example implementation illustrated in FIG. 1, three processor cores (116-1, 116-2, 116-M) represent an M (where M>=3) number of cores, the number of processor cores 116 implemented in CPU 114 is a matter of design choice. As such, in other implementations, CPU 114 can include any number of processor cores 116. The processor cores 116 are configured to execute instructions such as program code 108 for one or more applications (e.g., graphics applications, compute applications, machine-learning applications) stored in the memory 106. The CPU 114 can consume data 110 from the memory 106 and store information in the memory 106 such as the results 112 of the executed instructions.

An input/output (I/O) engine 118 is implemented with circuitry that handles input or output operations associated with display 120, as well as other elements of the processing system 100 such as keyboards, mice, printers, external disks, and the like. The I/O engine 118 is coupled to the bus 104 so that the I/O engine 118 communicates with the parallel processor 102, the memory 106, CPU 114, as well as other entities in the processing system 100.

Some embodiments of the processing system 100 include a platform security processor (PSP) 122 including circuitry that provides a trusted execution environment subsystem for the processing system 100. The PSP 122 is configured to create, monitor, and maintain a security environment for the processing system 100. Examples of functions that are implemented by the PSP 122 include, but are not limited to, managing the boot process, initializing security related mechanisms, and monitoring the processing system 100 for suspicious activity or events and implementing appropriate responses to any suspicious activity or events.

The parallel processor 102 includes one or more processor cores 130 that each operate as a compute unit configured to perform one or more operations based on one or more instructions received by the parallel processor 102. The compute units in the processor cores 130 are implemented as circuitry that include one or more single-instruction, multiple data (SIMD) units that perform the same operation on different data sets to produce one or more results. The parallel processor 102 also includes one or more physical functions (PFs) 132. In some embodiments, the physical function 132 is implemented with circuitry configured to perform one or more hardware acceleration functions such as multimedia decoding, multimedia encoding, video decoding, video encoding, audio decoding, and audio encoding.

The processing system 100 implements a virtual environment that supports the physical function 132 and a set of virtual functions (VFs). The VFs are exposed to guest virtual machines (VMs) such as virtual machines that are executing on the parallel processor 102. The parallel processor 102 further includes a set of resources 134 that store information associated with processing performed by kernel mode units. Subsets of the set of resources 134 are allocated to store information associated with the virtual functions. In some embodiments, subsets of the resources 134 are mapped to the virtual functions and the subsets are partitioned to include a frame buffer, context registers, a doorbell aperture, and one or more mailbox registers used for VF-PF synchronization. The physical function 132 executes on behalf of one of the virtual functions for one of the guest VMs based on the information stored in a corresponding one of the subsets, as discussed herein.

Components of the processing system 100 can be fabricated on the same die or on multiple interconnected dies. In some embodiments, the parallel processor 102 and the PSP 122 are fabricated on the same die and in other embodiments the PSP 122 and the CPU 114 are fabricated on the same die. Other groups of components can also be combined onto a single die. For example, the CPU 114, the PSP 122, and the parallel processor 102 can be fabricated on the same die. A system-on-a-chip (SOC) implementation can include the parallel processor 102, the memory 106, the CPU 114, the I/O engine 118, and the PSP 122 on the same die.

Some embodiments of the parallel processor 102 execute a host driver that selectively enables access to the resources by the VFs based on an operational state of the parallel processor 102. For example, the host driver enables access to the mailbox registers for all states of the VF executing on the parallel processor 102. The host driver disables access to the frame buffer, context registers, and doorbell during a first (default) state of the VF. The host driver enables access to the frame buffer, the context registers, and the doorbell during a second state of the VF to allow the VF to perform operations related to initializing, re-initializing, or resetting the VF. The VF executes normally in the third state. In some embodiments, the host driver selectively enables access to the subsets of the resources based on a risk level, a security level, or a threat level associated with the subsets. Some embodiments of the host driver enable access to the frame buffer and the doorbell but disable access to the context registers due to the relatively high risk/threat of exposing the context registers to the VF at runtime, e.g., relative to the lower risks/threats associated with the frame buffer, the doorbell, and the mailbox registers. In some embodiments, the parallel processor 102 implements a state machine (not shown in FIG. 1 the interest of clarity) that manages or modifies the states of the VF in the parallel processor 102.

As discussed herein, limiting or constraining access to subsets of the resources 134 based on the operational state of the parallel processor 102 can increase signaling overhead and latency in the parallel processor 102. A subset of the resources 134 are therefore designated as “safe” to be exposed to a VF at runtime. Designating safe registers in this manner can reduce the signaling overhead and latency incurred by VF requests to the host driver at runtime. For example, a VF can initiate reset or re-initialization of the VF by writing a request to a subset of context registers that are designated as safe to be exposed to the VF, instead of sending a request to the host driver. In some embodiments, the parallel processor 102 is configured to designate a subset of the resources 134 as safe to be exposed to the VF based on an operational state of the parallel processor 102. For example, if present, the PSP 122 can generate and provides signaling instructing the parallel processor 102 to designate a subset of the resources 134 as safe to be exposed to virtual functions implemented by the parallel processor 102.

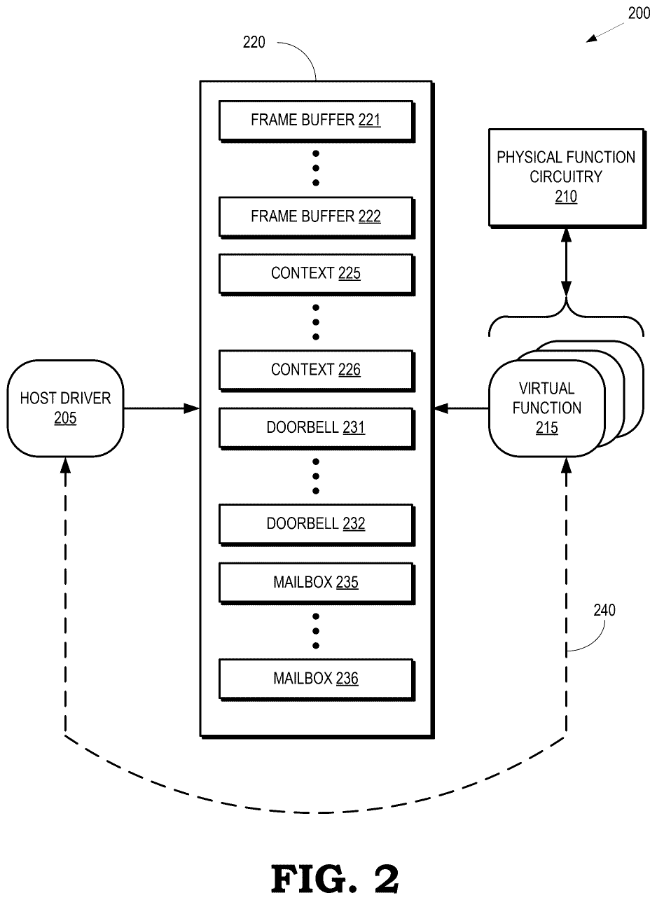

FIG. 2 is a block diagram of a processing system 200 that designates resources as “safe” to be accessed by VFs at runtime, according to some embodiments. The processing system 200 is used to implement some embodiments of the processing system 100 shown in FIG. 1. In the illustrated embodiment, the processing system 200 includes physical function circuitry 210 and implements a host driver 205 and one or more virtual functions (VFs) 215 that execute on the physical function circuitry 210, as discussed herein.

The processing system 200 implements a set 220 of resources that are allocated to the VFs 215 executing on the physical function circuitry 210. In the illustrated embodiment, the set 220 is partitioned into subsets of resources that are allocated to different VFs 215. For example, the subset of the resources that is reserved for frame buffers is partitioned into a frame buffer subset 221 that is allocated to the VF 215 and one or more other frame buffer subsets 222 that are allocated to other virtual functions. The subset of the resources that is reserved for context registers is partitioned into a context subset 225 that is allocated to the VF 215 and one or more other context subsets 226 that are allocated to other virtual functions. The subset of the resources that is reserved for doorbells is partitioned into a doorbell 231 that is allocated to the VF 215 and one or more other doorbells 232 that are allocated to other virtual functions. The subset of the resources that is reserved for mailbox registers is partitioned into the mailbox subset 235 that is allocated to the VF 215 and one or more other mailbox subsets 236 that are allocated to other virtual functions.

During initialization of the VF 215 (or other virtual functions), the host driver 205 provides signaling 240 to the VF 215 (or other virtual functions) that selectively enables the VF 215 to access to the frame buffer 221, context registers 225, doorbell 231, and mailbox registers 235 that are allocated to the VF 215. However, in some cases, the host driver 205 concurrently writes information to one or more of the frame buffer 221, the context registers 225, or the doorbell 231 on behalf of the VF 215 that owns these registers. Thus, the content of the resources can become corrupted or race conditions can be created by successive uncoordinated writes to the resources by the VF 215 and the host driver 205. Corruption or race conditions can also be created during a reset of the VF 215 and corresponding resources 221, 225, 231. The host driver 205 therefore uses the signaling 240 to selectively enable subsets of the set 220 of resources based on an operational state of the corresponding VF 215.

Additional subsets (or subsets of the subsets of the set 220) are designated as safe for access by the virtual function 215 (or other virtual functions). In some embodiments, the host driver 205 designates a subset of the context registers 225 as safe to be exposed to the virtual function 215. For example, the host driver 205 can designate the safe subset of the context registers 225 by specifying an address of a register in the subset, a register size, a starting address of the safe range of registers, an ending address of the safe range of registers, a combination thereof, or using other indications of the safe subset of the context registers 225. Different addresses, sizes, or ranges of safe subsets can be allocated to different virtual functions or groups of virtual functions. Once designated, the virtual function 215 can initiate a reset or reinitialization of the virtual function by writing a request to the designated safe subset of the context registers 225. Some embodiments of the physical function circuitry 210 can disable access to the safe subset in response to detecting a state change of the virtual function 215 to provide additional security and resistance to intrusion or hacking attempts such as fuzzer attacks or denial of service attacks.

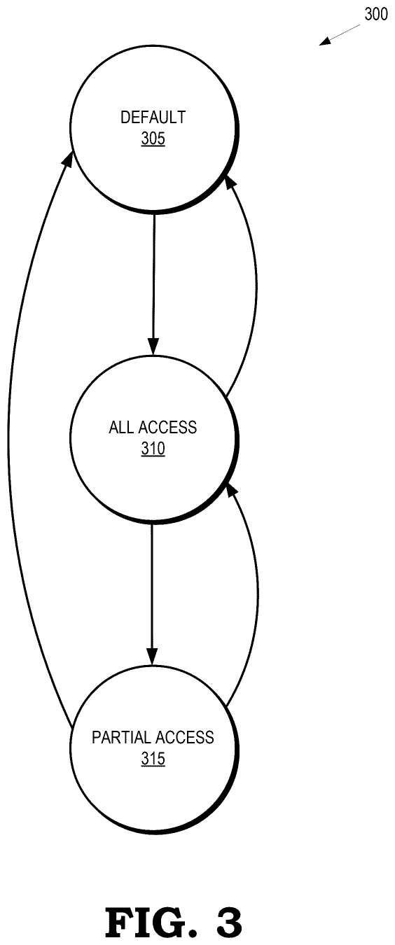

FIG. 3 is a block diagram of a state machine 300 that is used to determine the state of a VF and selectively enable resources access by the VF according to some embodiments. The state machine 300 is implemented in some embodiments of the processing system 100 shown in FIG. 1 and the processing system 200 shown in FIG. 2. In the illustrated embodiment, the state machine 300 provides a set of states and defines transitions between the states for the VF. The set of states includes a default state 305 that is applied to the VF when the conditions for the other states are not satisfied by the VF. The set of states also includes an “all access” state 310 that is used to initialize, re-initialize, or reset the VF and a “partial access” state 315 that is used during runtime for the VF.

In operation, the state machine 300 places the VF in the default state 305 if there is no other appropriate state for the VF. For example, the state machine 300 places the VF in the default state 305 in response to a world switch when the processing unit stops or suspends execution of the VF and changes to executing another VF. In the default state 305, the host driver disables access to the frame buffer, the context registers, and the doorbell. The host driver also enables access to the mailbox registers in the default state 305 to support communication between the VF and the PF that implements the VF.

The state machine 300 modifies the state of the VF to the “all access” state 310 during initialization, re-initialization, or reset of the VF. For example, the state machine 300 places the VF in the “all access” state 310 in response to the processing unit initializing the VF. The host driver enables access to the frame buffer, the context registers, the doorbell, and the mailbox registers when the VF is in the “all access” state 310. The VF can therefore perform configuration operations related to initiating or resetting the VF by writing information to the frame buffer, the context registers, the doorbell, or the mailbox registers, as necessary. Limiting the “all access” state 310 to time intervals used for initialization, re-initialization, or reset of the VF also reduces the risk of exposing the contents of the registers.

However, if the state machine 300 detects a failure of a driver associated with the VF or an invalid, unsupported, or malicious driver, e.g., in response to initializing the VF and the corresponding driver, the state machine 300 transitions the VF from the “all access” state 310 to the default state 305. The host driver disables access to the frame buffer, the context registers, and the doorbell in the default state 305 to prevent corruption or malicious modification of the contents of these resources. The state machine 300 remains in the default state 305 until the current driver is re-initialized with a valid driver or a new driver is loaded, in which case the state machine 300 transitions back to the “all access” state 310 to continue initializing, re-initializing, or resetting the VF.

The state machine 300 transitions from the “all access” state 310 to the “partial access” state 315 in response to completing initialization, re-initialization, or resetting of the VF. The “partial access” state 315 is used during runtime of the VF. In some embodiments, access to subsets of the resources is determined based on a risk level, a security level, or a threat level associated with the subsets. Some embodiments of the state machine 300 enable access to the frame buffer and the doorbell in the “partial access” state 315 but disable access to the context registers due to the relatively high risk associated with allowing access to the context registers. As discussed herein, disabling access to the context registers in the “partial access” state 315 tends to increase signaling overhead and latency, e.g., for communication between the virtual function 215 and the host driver 205 shown in FIG. 2. A subset of the context registers is therefore designated as “safe” for VF access in the “partial access” state 315. Other combinations of registers are enabled or disabled or designated as “safe” in other embodiments.

The state machine 300 transits the state of the VF back to the “all access” state 310 in response to a driver unload event and transits to the default state 305 in response to end of the usage VF notification or in response to the detection of end of VF usage. If the state machine 300 receives a notification of end of VF usage, the state machine 300 transitions the VF from the “all access” state 310 to the default state 305. The host driver disables access to the frame buffer, the context registers, and the doorbell in the default state 305 to prevent corruption or malicious modification of the contents of these resources. The state machine 300 remains in the default state 305 until a new driver is loaded, in which case the state machine 300 transitions back to the “all access” state 310 to continue initializing, re-initializing, or resetting the VF.

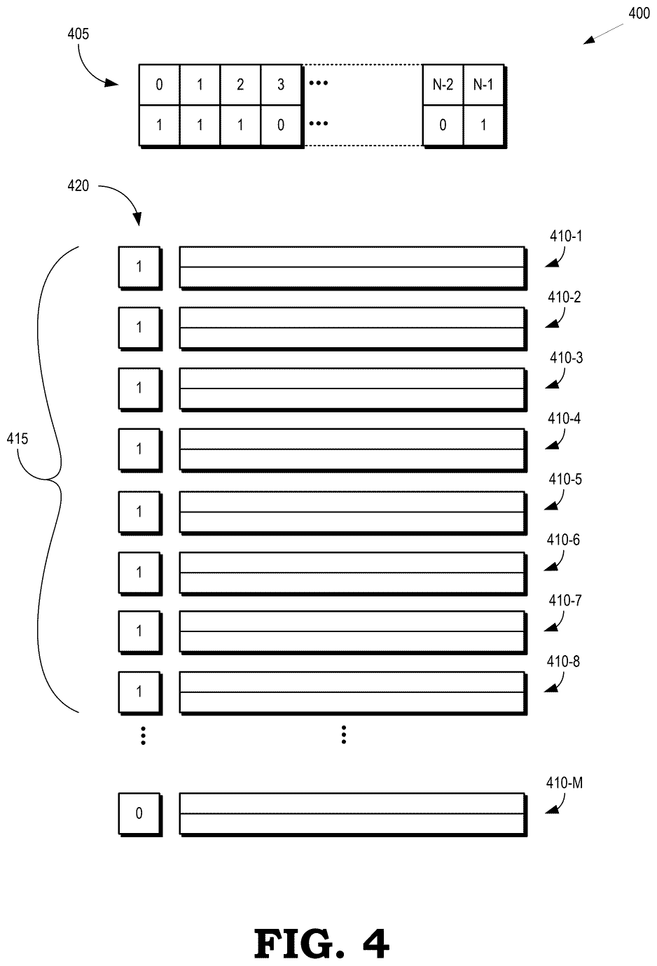

FIG. 4 illustrates resources 400 of a parallel processor according to some embodiments. The resources 400 can be used to implement the resources 134 in the processing system 100 shown in FIG. 1 and the resources 220 shown in FIG. 2. For example, the resources 400 can be used to implement the frame buffers 221, 222, context registers 225, 226, doorbell 231, 232, and mailbox registers 235, 236 shown in FIG. 2. Subsets of the resources 400 are designated as “safe” registers that are accessible by one or more virtual functions at runtime.

In the illustrated embodiment, the resources 400 include registers 405 (or other storage resources) that store information indicating whether safe registers have been designated for corresponding virtual functions. The registers 405, which can be referred to as check_enable registers, include enable bits that indicate which of the N virtual functions supported by the processing system have been allocated a subset of the resources 400 that are designated as safe registers. A value of the enable bit of “0” indicates that the corresponding virtual function has not been allocated any safe registers and an enable bit of “1” indicates that the corresponding virtual function has been allocated a range of safe registers from the resources 400. For example, virtual functions labeled by the indices 0-2 and N-1 are associated with enable bits that are set to “1,” which indicates that these virtual functions have been allocated a range of safe registers. For another example, virtual functions labeled by the indices 3 and N-2 are associated with enable bits that are set to “0,” which indicates that these virtual functions have not been allocated a range of safe registers.

The resources 400 also include pairs 410 of registers that are used to implement frame buffers, context registers, doorbells, mailbox registers, and the like. In the illustrated embodiment, the resources 400 include M register pairs 410, as indicated by the reference numerals 410-1 . . . M. A subset 415 of the register pairs 410 are designated as safe registers for one or more virtual functions. The register pairs 410-1 . . . 8 in the subset 415 are therefore accessible by one or more virtual functions at runtime. In the illustrated embodiment, a set of bits 420 is used to indicate whether a corresponding register pair 410 is in the safe subset 415. For example, values of the bits 420 associated with the register pairs 410-1 . . . 8 are set to “1” to indicate that they have been designated as safe for access by the one or more virtual functions at runtime. The subset 415 can also be indicated by register addresses, a range of addresses, a size of the subset 415, and the like. For example, the safe subset 415 can be indicated by specifying one or more start/end address pairs, such as the starting address of the register pair 410-1 and the ending address of the register pair 410-8.

As discussed herein, virtual functions can access safe subsets of registers, such as the safe subset 415, at runtime or in other operational modes of the processing system. In some embodiments, the virtual functions are limited, restricted, or constrained to accessing registers in the safe subset in some modes. Physical function circuitry (such as the physical function circuitry 210 shown in FIG. 2) can deny the virtual function access to portions of the resources 400 that are not designated as safe in a first operating mode, such as a “mission mode.” The physical function circuitry can allow the virtual function access to the portions of the resources 400 that are not designated as safe in a second operating mode, such as an “exclusive mode.” Allowing virtual functions access to resources that are not designated as safe permits entities such as a driver to perform functions such as hardware initialization in the exclusive mode. The mission mode or exclusive mode can be indicated by a value of stored information. For example, a first value of a register VF_REGWR_EN=1′b0 indicates the mission mode and a second value of the register VF_REGWR_EN=1′b1 indicates the exclusive mode.

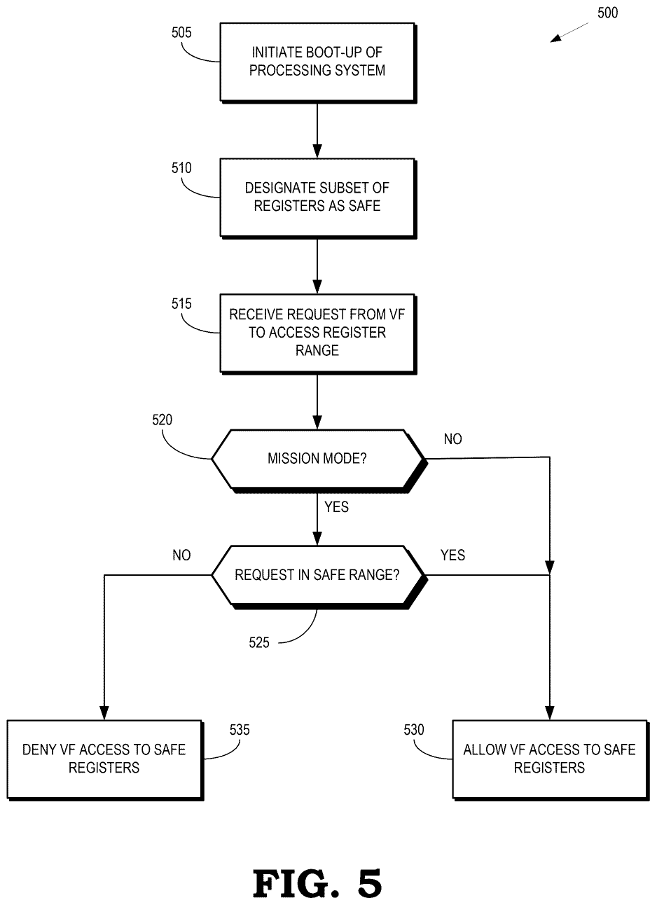

FIG. 5 is a method 500 of designating subsets of registers as safe for access by one or more virtual functions according to some embodiments. The method 500 is implemented in some embodiments of the processing system 100 shown in FIG. 1 and the processing system 200 shown in FIG. 2.

At block 505, boot up of the processing system (or a parallel processor within the processing system) is initiated. In some embodiments, boot up is initiated by a platform security processor such as the PSP 122 shown in FIG. 1. In response to initiating boot up, the method 500 flows to the block 510.

At block 510, a subset of resources in the processing system is designated as safe for access by one or more virtual functions. For example, as discussed herein, the PSP can designate a subset of registers, such as context registers, as safe for access by one or more virtual functions at runtime. The PSP can designate the safe subset by specifying a register address, a size of the safe subset, a range of register addresses, a starting address of one or more registers, an ending address of one or more registers, and the like.

At block 515, a request is received from the virtual function to access a range of registers. In some embodiments, the request indicates a base address (addr) and a size or range (reg_size) of the requested registers.

At decision block 520, the processing system (or parallel processor within the processing system) determines whether the processing system is operating in a mission mode or an exclusive mode. If the processing system is operating in the mission mode, the method flows to the decision block 525. Otherwise, if the processing system is not operating in the mission mode and is operating in the exclusive mode, the method 500 flows to block 530.

At decision block 525, the processing system (or parallel processor within the processing system) determines whether the requested register addresses are within the range that are designated as safe subsets of the registers. For example, the processing system can compare the requested address range (addr+reg_size) to the range indicated by the starting address and ending address of the safe subset of the registers. If the entirety of the requested address range falls within the range of the safe subset, the method 500 flows to block 530. Otherwise, if any portion of the requested address crosses the check boundary, and therefore lies outside of the range of the safe subset, the method 500 flows to the block 535.

At the block 530, the virtual function is allowed to access registers in the safe subset. At the block 535, the virtual function is denied access to the registers in the safe subset.

In some embodiments, the apparatus and techniques described above are implemented in a system including one or more integrated circuit (IC) devices (also referred to as integrated circuit packages or microchips), such as the processing system described above with reference to FIGS. 1-5. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above can be implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. An apparatus comprising:
a plurality of resources configured to store information;
physical function circuitry configured to execute a virtual function using information stored in the plurality of resources; and
a processing unit configured to designate a subset of the plurality of resources as safe to be exposed to the virtual function based on an operational state of the processing unit.

2. The apparatus of claim 1, wherein the operational state of the processing unit comprises one of: a first state that is a default state of the virtual function, a second state of the virtual function that is used for initialization, re-initialization, and reset of the virtual function, or a third state of the virtual function in which the virtual function is executing on the physical function circuitry.

3. The apparatus of claim 2, wherein the processing unit is configured to designate the subset of the plurality of resources as safe to be exposed to the virtual function in the third state of the virtual function.

4. The apparatus of claim 3, wherein the plurality of resources comprises frame buffers, context registers, doorbell registers, and mailbox registers that are selectively accessible to the virtual function based on the operational state of the processing unit, and wherein the processing unit is configured to designate a subset of the context registers as safe to be exposed to the virtual function.

5. The apparatus of claim 4, wherein the virtual function is configured to initiate at least one of reset or re-initialization of the virtual function by writing a request to the subset of the context registers designated as safe to be exposed to the virtual function.

6. The apparatus of claim 1, wherein the processing unit is configured to designate the subset of the plurality of resources as safe to be exposed to the virtual function based on at least one of an address, a register size, a starting address, or an ending address associated with the subset of the plurality of resources.

7. The apparatus of claim 1, wherein the physical function circuitry is configured to disable access to the subset of the plurality of resources designated as safe to be exposed to the virtual function in response to detecting a state change of the virtual function.

8. The apparatus of claim 1, wherein the physical function circuitry is configured to deny the virtual function access to portions of the plurality of resources that are not designated as safe in a first operating mode, and wherein the physical function circuitry is configured to allow the virtual function access to the portions of the plurality of resources that are not designated as safe in a second operating mode.

9. A method comprising:
executing, on physical function circuitry in a processing unit, a virtual function using information stored in a plurality of resources; and
designating a subset of the plurality of resources as safe to be exposed to the virtual function based on an operational state of the processing unit.

10. The method of claim 9, wherein the operational state of the processing unit comprises one of: a first state that is a default state of the virtual function, a second state of the virtual function that is used for initialization, re-initialization, and reset of the virtual function, and a third state of the virtual function in which the virtual function is executing on the physical function circuitry, wherein designating the subset of the plurality of resources as safe comprises designating the subset of the plurality of resources as safe to be exposed to the virtual function in the third state of the virtual function.

11. The method of claim 10, wherein the plurality of resources comprises frame buffers, context registers, doorbell registers, and mailbox registers that are selectively accessible to the virtual function based on the operational state of the processing unit, and wherein designating the subset of the plurality of resources as safe comprises designating a subset of the context registers as safe to be exposed to the virtual function.

12. The method of claim 11, further comprising:
writing a request to the subset of the context registers designated as safe to be exposed to the virtual function to initiate at least one of a reset or a re-initialization of the virtual function.

13. The method of claim 9, wherein designating the subset of the plurality of resources as safe to be exposed to the virtual function comprises designating the subset of the plurality of resources as safe based on at least one of an address, a register size, a starting address, or an ending address associated with the subset of the plurality of resources.

14. The method of claim 9, further comprising:
disabling access to the subset of the plurality of resources designated as safe to be exposed to the virtual function in response to detecting a state change of the virtual function.

15. The method of claim 9, further comprising:
denying the virtual function access to portions of the plurality of resources that are not designated as safe in a first operating mode; and
allowing the virtual function access to the portions of the plurality of resources that are not designated as safe in a second operating mode.

16. An apparatus comprising:
a plurality of resources configured to store information;
physical function circuitry configured to execute a first virtual function using information stored in the plurality of resources; and
a processing unit configured to selectively expose a first subset of the plurality of resources to the first virtual function at runtime.

17. The apparatus of claim 16, wherein the processing unit is configured to disable access to the first subset of the plurality of resources in response to detecting a state change of the virtual function.

18. The apparatus of claim 16, wherein the processing unit is configured to deny the virtual function access to a portion of the plurality of resources that is not in the first subset in a first operating mode; and wherein the processing unit is configured to allow the virtual function access to the portion of the plurality of resources that is not in the first subset in a second operating mode.

19. The apparatus of claim 16, wherein the physical function circuitry is configured to execute a second virtual function using the information stored in the plurality of resources, and wherein the processing unit is configured to designate a second subset of the plurality of resources as safe to be exposed to the second virtual function at runtime.

20. The apparatus of claim 19, wherein at least one of a number, a size, an address, a number of registers, a register size, a starting address of a register, or an ending address of a register in the first subset is different than at least one of a number, a size, an address, a number of registers, a register size, a starting address of a register, or an ending address of a register in the second subset.
